(19) United States
(12) Patent Application Publication
(10) Pub. No.: US 2017/0071403 A1
(43) Pub. Date: Mar. 16, 2017

(54) Programmable Self-Cooker

(71) Applicants: Sandeep Thumthajira, Farmington Hills, MI (US); Gayathri Panjipalla Nagappa, Farmington Hills, MI (US)

(72) Inventors: Sandeep Thumthajira, Farmington Hills, MI (US); Gayathri Panjipalla Nagappa, Farmington Hills, MI (US)

(21) Appl. No.: 15/262,926

(22) Filed: Sep. 12, 2016

Related U.S. Application Data
(60) Provisional application No. 62/216,773, filed on Sep. 10, 2015.

(51) Int. Cl. A47J 36/32; A47J 27/12; A47J 36/16

(52) U.S. Cl. CPC A47J 36/32; A47J 36/16; A47J 27/12; A47J 36/165

(57) ABSTRACT

Programmable Self-Cooker, would allow to cook customized recipe. The 4 Compartments would allow to store the ingredients which would be dropped into the Cooking Pan/Bottom at programmed intervals/time delays. The Compartment Opener would open based on the Spring action, which would be electronically controlled. The time delays or time intervals can be fed manually or be programmed through customized software recipe which could be downloaded. The Cooker would be fitted with a Camera option for Remote viewing/Cooking. The Heating of the Pan and also the control mechanism for the Compartments and the CAN's and the stirrer would be controlled through a Central Control Unit.

### CROSS-REFERENCE TO RELATED APPLICATIONS

The present invention claims priority to U.S. Provisional Patent Application Ser. No. 62/216,773, filed Sep. 10, 2015 entitled “Programmable Cooker”, the disclosure of which is hereby incorporated in its entirety by reference.

### BACKGROUND

Currently in the Market there are a lot of available Rice & Slow Cookers. However they cook for a single recipe. Usually people would like to cook their own customized recipes, in their own cooking style which could be shared with others also. This invention is more towards cooking their own programmable/Customized recipe automatically. This is done by placing the ingredients in small compartments and having a mechanism to choose and drop the necessary ingredients into the cooking pan at a specific time/programmed time with necessary time delays. This would replicate self cooking in an automated way.

### BRIEF SUMMARY OF THE INVENTION

Appliance will have a Bottom and Upper Part. The Bottom Part would include a Base/Cooking Pan, with the stirrer, Heating Coil and the upper part would consist of detachable Mini Compartments, control mechanism and the CAN's. One of the Compartment would have an option for in-build chopper/puree maker. The Mini-Compartment can be either in Square, Rectangular or Circular in shape. The Mini Compartments are for placing Meat, Rice and various Ingredients such as salt, Pepper, Masala Powders etc.

Two separate Externally Fitted cans would be provided which will have oil & water attached to the unit. The Oil & Water would be dropped into the pan through an outlet from the respective Can's, controlled by the Control Unit. A stirring unit would be provided, which would stir the ingredients. The stirrer would be in the centre, connected to the base and controlled through the Control Unit. The Stirrer can also be connected to the Top Part of the Cooker. The Stirrer and the Base PAN would be removable for washing.

A programmable module will fed recipe into the memory with time delays which will allow cooking to be done at a specific time as per the programmed steps. This program can be included through the external buttons or be downloaded through the customized e-recipe from internet. The bottom one will be the cooking pan, where the ingredients will fall as per the programmed menu with customized time delays. Equipment will have safety OFF option, based on temperature and or pressure sensors. A pressure release opening will be provided connected to the bottom half of the cooker. The Pressure release will have an outlet at the Upper Part of the Cooker.

Cooker will have access to Internet/IP Network, through which Online Posted menu or recipe can be configured and downloaded. Recipes can be exchanged by users through Internet and the same can be downloaded into the cooker's programmable unit. Each recipe can be rated and stored for future reference for self use or to be exchanged with others. The Cooker will be provided with a Camera option, which can aid in viewing and remote control of the cooker and its operations, including Start or Stop or change the sequence of operations. The amount of heat to be provided to the pan, would be controlled through the control unit at different times as per the recipe. This could be achieved through Induction Heating.

### BRIEF DESCRIPTION OF THE FIGURES

FIG. 1, is a Programmable Self-Cooker according to present Invention. It gives an overall external view of the cooker with the buttons and the control module.

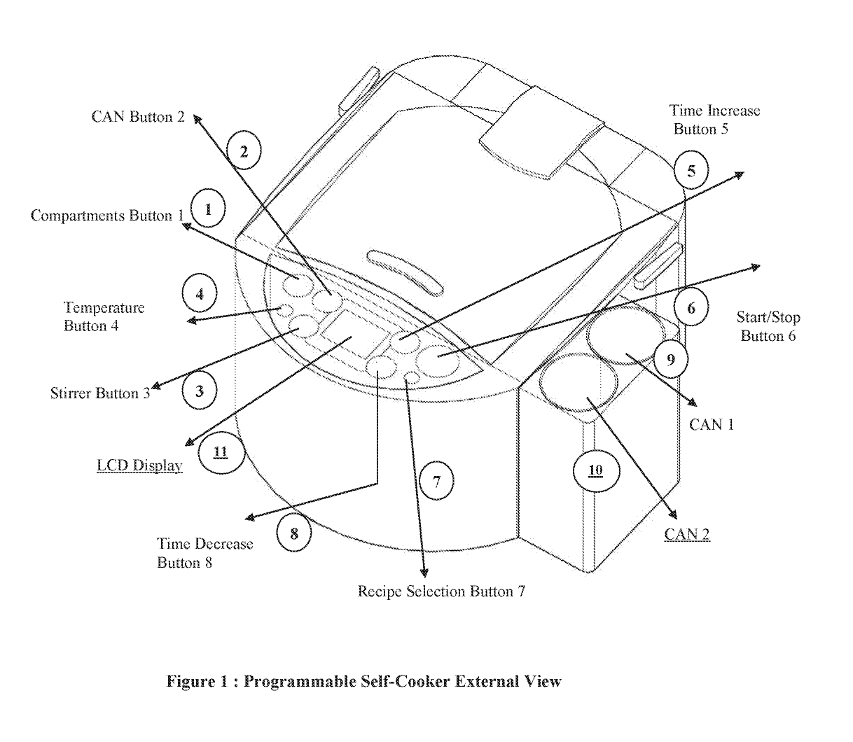

FIG. 2, is a Programmable Self-Cooker Top View along with the Mini-Compartments. Details of the picture below.

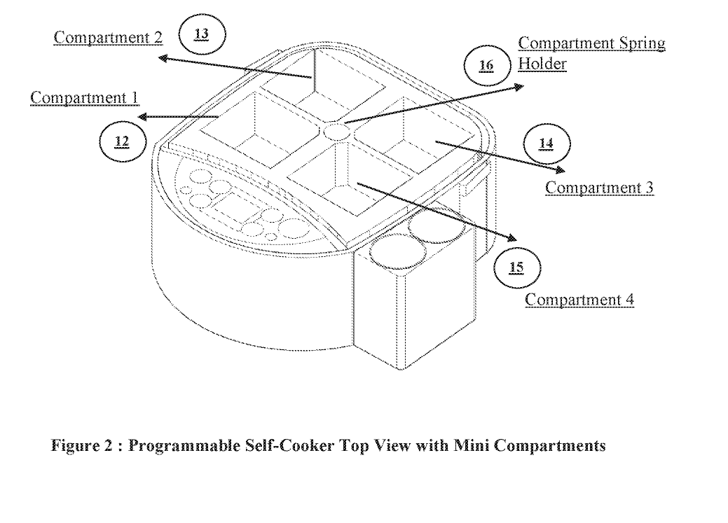

FIG. 3, is a Programmable Self-Cooker Cross Sectional View. This shows the Top and Bottom part of the Cooker along with the Compartments and the Cooking Base pan and the stirrer

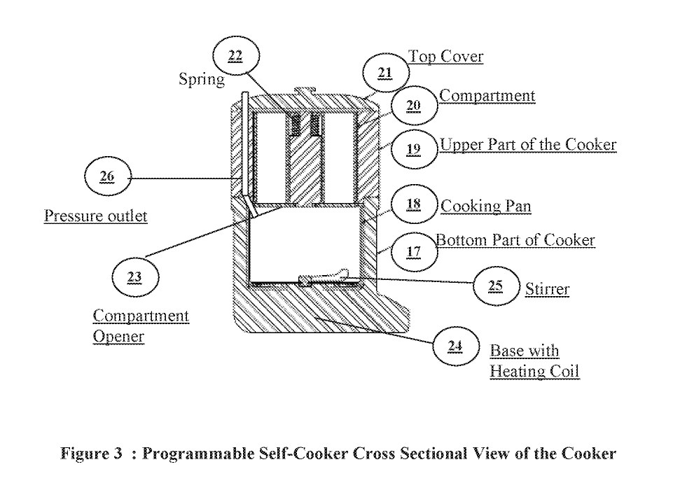

FIG. 4, depicts the Electronics Control Module for the Programmable Self-Cooker, to control the Heating Unit, Stirrer, CAN's and Mini Compartment opener.

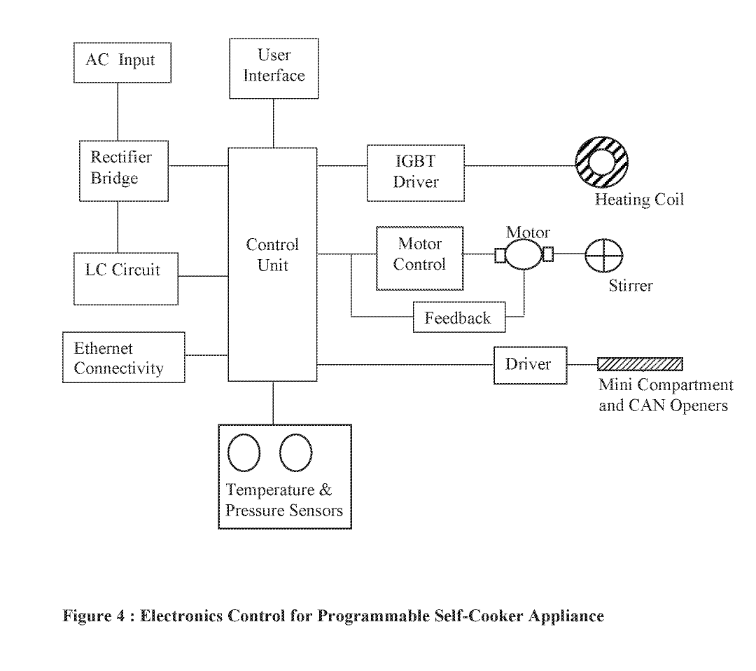

FIG. 5, depicts a Sample recipe flow chart showing the operation of the Cooker, how it can operate Automatically.

### DETAILED DESCRIPTION AND BEST MODE OF IMPLEMENTATION

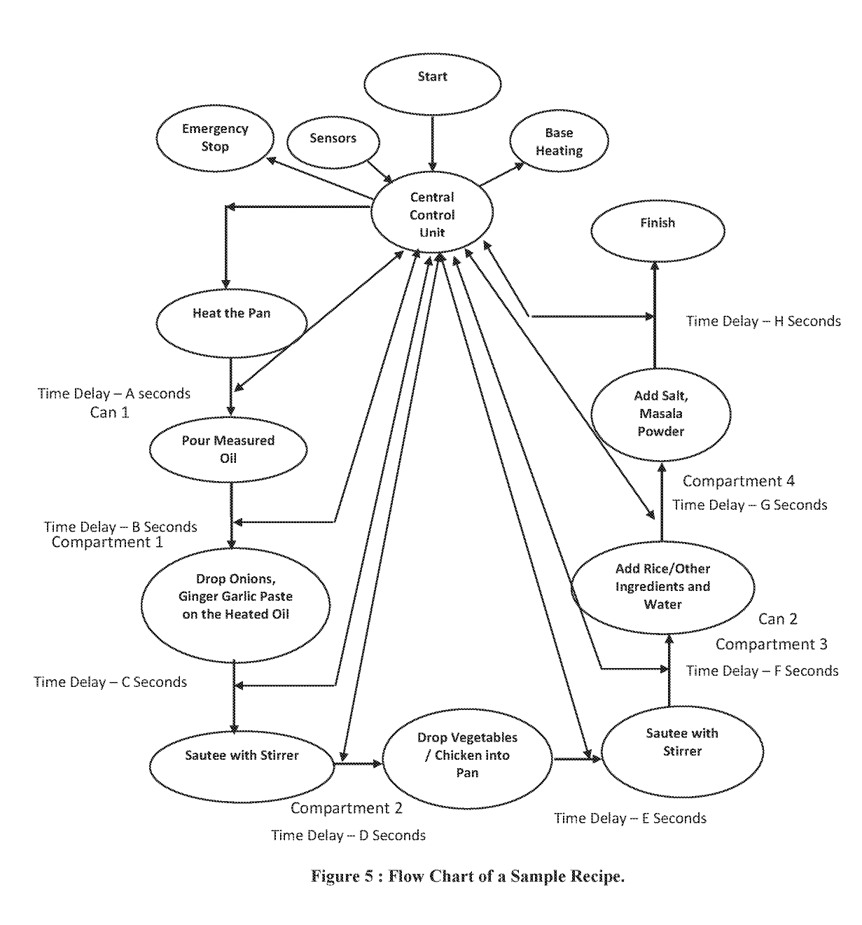

The flow chart in FIG. 5, depicts a sample recipe being cooked. The Cooker has two parts: Upper part of the cooker (No 19), which houses the 4 Mini Compartments (No's 12,13,14,15), Required Springs (No 22), CAN's (No's 9,10) and the Bottom part of the Cooker (17) which comprises of the cooking pan (No 18), Stirrer (No 25), base with the heating Coil (No 24). Additionally the Cooker houses the control unit, which has Buttons to control the cooking and choose the recipe.

The 4 Mini COMPARTMENTS (No's 12,13,14,15) along with the 2 CAN'S (No's 9,10) and the STIRRER (No 25) are time controlled through the BUTTON'S (No's 1,2,3,5,8,9,10) or through the software e-recipe. The time delays added would be seen through the LCD Display (No 11) unit, which would also aid in saving the recipes for future use or for improvements in the cooking. The Compartments would have openings (No 23) at the bottom, which would open/close at the respective time delays, controlled through a Central Control Unit. The Spring (No 22, 16) action will enable the compartment opening controlled electrically. The Time delays could be manually fed through the BUTTON'S (No's 5,8) or through the programmed Software Recipe which could be downloaded through Ethernet connectivity. The Heating (No 24) of the PAN (No 18), the STIRRER (No 25) and the COMPARTMENTS (No's 12,13,14,15) would be controlled respectively through the program. The 2 CANS (No's 9,10) would be made of Non-Combustible material, such that during cooking, the Oil/Water inside the CANS would not get heated. The 2 CANS would be provided with outlets into the PAN, which would be further controlled through time delays. The Cooker would be fitted with Safety sensors which would Turn-off the cooker during emergency/overheat scenario. A Start/Stop option would be provided through button (No 6). A Pressure release outlet (No 6) would be provided from the bottom part of the cooker and released outside through the Upper Part of the Cooker.

The Cooker would be provided with a Camera option, which can aid the cooking with/without remote control option. The Upper Compartments would be easily detachable such that it can be easily fit and be cleaned in a Washer. The Cooker would have Ethernet Connectivity, which would allow access to the Internet and also to download the e-recipes. The ingredients to be placed in the compartments can be decided by the user and also be provided with suitable time delays which would cook the food as per the users taste and needs. Ideal Cooking would depend based on the Time Delays/time intervals provided and the respective temperature settings. This Temperature setting will be set by the Button (No 4) or through the downloaded software e-Recipe. Hence user would have the option of storing few recipes in the memory, based on the cooking outcome. User can also choose a particular recipe he likes using the respective Button (No 7).

The Recipe here would be defined by the set of instructions to control the Compartments, Stirrer & CAN's with respective time delays or Time Intervals defined along with the necessary temperature settings. This would be further made as an e-recipe in a particular format which can be shared across online, which can be downloaded by others.

What is claimed is:

1. A programmable self-cooker appliance, comprising of:
a) a cooking base with a controlled stirrer which connects to a controlled heating unit;
b) a centrally control unit to control the controlled stirrer and the controlled heating unit;
c) an upper compartment with detachable mini compartments;
d) an electrically controlled compartment opener for the detachable mini compartments; and
e) an e-recipe programmed manually or downloaded through the Internet.

2. The programmable self-cooker according to claim 1, wherein the appliance consists of two separate parts including an upper and a bottom part, wherein the upper part having the detachable mini compartments with an electrically controlled compartment opener, and the bottom part having the controlled heating unit attached to the cooking base.

3. The programmable self-cooker according to claim 2, wherein the centrally control unit which controls the controlled heating unit, the stirrer, and the compartments.

4. The programmable self-cooker according to claim 1, wherein the cooking base and the stirrer are connected and controlled as per the programmed e-recipe.

5. The programmable self-cooker according to claim 1, wherein the controlled heating unit is controlled by the centrally control unit as per the programmed e-recipe.

6. The programmable self-cooker according to claim 3, wherein the compartments open and close at specific delays and/or time intervals as per the programmed e-recipe.

7. The programmable self-cooker according to claim 1, wherein a recipe is manually loaded into a memory unit with the help of buttons and a display unit.

8. The programmable self-cooker according to claim 1, wherein the e-recipe is downloaded into the memory unit through the Internet via an Ethernet or wireless connection.

9. A method of using a programmable self-cooker, comprising steps:
a) placing ingredients in a plurality of compartments;
b) configuring a recipe through a display unit having buttons with necessary time delays or downloading an e-recipe online through the Internet;
c) ingredients falling to a base cooking pan as per the recipe through time delay controlled compartments and a plurality of cans;
d) controlled heating of the base cooking pan as per the recipe; and
e) cooking at a bottom pan with a stirrer as per the recipe.

10. The programmable self-cooker according to claim 9, wherein the cooking is controlled through an inbuilt camera in the self-cooker.

11. The programmable self-cooker according to claim 9, wherein the ingredients comprise liquid ingredients stored separately in the plurality of cans mounted to the self-cooker and dropped into the base cooking pan as per the recipe.

12. The programmable self-cooker according to claim 9, wherein a small pressure release outlet from the bottom pan and released outside through a top portion of the self-cooker.

13. The programmable self-cooker according to claim 12, wherein a plurality of mini-compartments is used to store ingredients and is connected to the bottom pan.

14. The programmable self-cooker according to claim 13, wherein the plurality of mini-compartments are electrically controlled as per the recipe.

15. The programmable self-cooker according to claim 14, wherein the plurality of mini-compartments are opened through a spring action controlled by a central control unit.

16. The programmable self-cooker according to claim 15, further comprising a temperature and/or pressure sensors connected to the central control unit to enable emergency stop/shut off of the self-cooker.
